(19) United States
(12) Patent Application Publication
(10) Pub. No.: US 2016/0010754 A1
(43) Pub. Date: Jan. 14, 2016

(54) ROTATING VALVE TRIM

(71) Applicant: Cameron International Corporation, Houston, TX (US)

(72) Inventors: Kevin P. Minnock, Houston, TX (US); Raymond Pirie, Aberdeen (GB)

(21) Appl. No.: 14/330,218

(22) Filed: Jul. 14, 2014

(51) Int. Cl. F16K 5/04

(52) U.S. Cl. CPC F16K 5/04

(57) ABSTRACT

Various valves for regulating flow are provided. In one embodiment, a valve includes a hollow body with an inlet and an outlet and a trim disposed inside the hollow body. The trim includes a control component that can be moved to regulate flow from the inlet to the outlet. An actuator is coupled to the trim and enables both linear movement of the control component and rotational movement of the control component within the hollow body during operation of the valve. Additional systems, devices, and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

In order to meet consumer and industrial demand for natural resources, companies often invest significant amounts of time and money in finding and extracting oil, natural gas, and other subterranean resources from the earth. Particularly, once a desired subterranean resource such as oil or natural gas is discovered, drilling and production systems are often used to access and extract the resource. These systems may be located onshore or offshore depending on the location of a desired resource.

Further, such systems generally include a wellhead assembly mounted on a well through which the resource is accessed or extracted. These wellhead assemblies can include a wide variety of components, including chokes and other valves for regulating fluid flow. Other fluid conduits and systems can also use valves and chokes in a similar manner. Such valves typically include internal components (i.e., trims) for selectively obstructing fluid passages to allow control of fluid flow through the valves. The valve trims can wear over time due to erosion by the fluid flow. This wear can impact the performance of the valves and reduce the operating life of the valve trims.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to valves for regulating the flow of fluids through conduits. In at least some embodiments, adjustable chokes or other control valves are provided with trims having components that are rotated to distribute erosive wear on the trims. For example, in one embodiment a trim includes a plug for selectively closing ports in a cage to regulate flow through the ports. Flow through the ports can erode portions of the plug used to close the ports. The plug can be rotated with respect to the cage to distribute this erosive wear over a larger area and extend the wear life of the trim.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 is a block diagram of a system having various chokes and other valves for regulating fluid flow in accordance with one embodiment;

FIG. 2 is a block diagram depicting a valve operated by a motor-driven actuator in accordance with one embodiment;

FIG. 3 is a cross-section of a valve having a plug-and-cage trim in accordance with one embodiment;

FIG. 4 is a perspective view of a plug-and-cage valve trim in accordance with one embodiment;

FIG. 5 depicts the plug of the valve trim of FIG. 4 in accordance with one embodiment;

FIG. 6 generally shows wear channels that can be formed in the plug of FIG. 5 from flow through the ports of the cage selectively covered by the plug;

FIG. 7 depicts wear that is distributed more evenly about the circumference of the plug of FIG. 5 by rotating the plug, in accordance with one embodiment, to change the areas of the plug exposed to flow through the ports of the cage;

FIG. 8 is a block diagram of a valve system similar to FIG. 2, but further depicting the actuator as having a solenoid-controlled anti-rotation pin that selectively permits the actuator to rotate a valve trim component in accordance with one embodiment; and

FIG. 9 is a perspective view of a sleeve trim having a control component that can be rotated in accordance with one embodiment.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

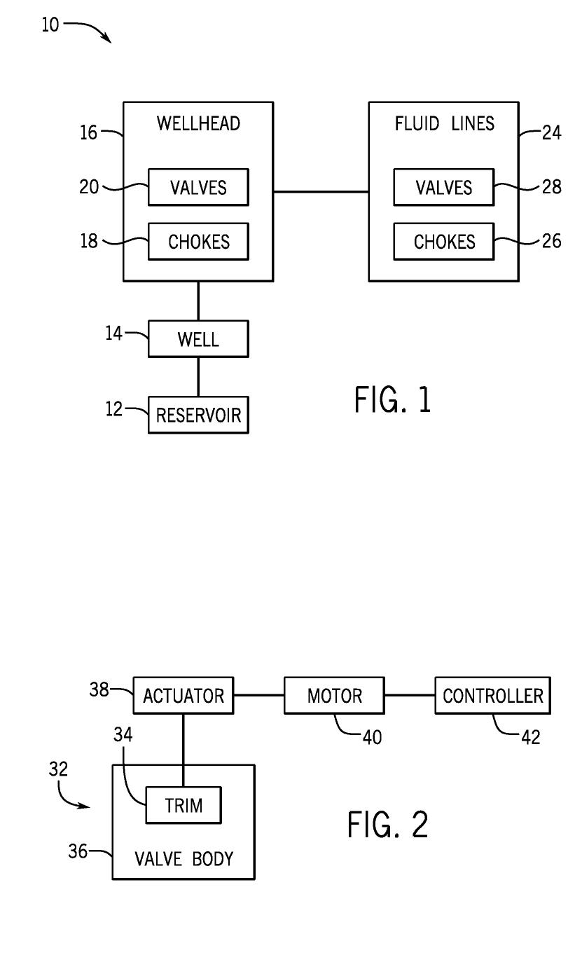

Turning now to the present figures, a system 10 is illustrated in FIG. 1 in accordance with one embodiment. In some instances, the system 10 is a production system that facilitates extraction of a resource, such as oil or natural gas, from a reservoir 12 through a well 14. Wellhead equipment 16 is installed at the well 14. The wellhead equipment 16 can include chokes 18 and other valves 20, as well as additional components (e.g., casing heads and a tubing head). The chokes 18 and valves 20 regulate flow of various fluids at the wellhead equipment 16. In at least some embodiments, a choke 18 is an adjustable choke that receives fluid (e.g., production fluid) and can be actuated to change the amount of fluid flow through its body. Adjustable chokes can include various trims, like plug-and-cage trims, sleeve trims, or needle-and-seat trims, for instance. The valves 20 can include any of various types of valves, and can serve as control valves that can be actuated to change the rate at which fluid flows through their respective bodies.

Fluids may be conveyed to or from the wellhead equipment 16 through fluid lines 24. Examples of such fluid lines 24 include pipelines, flowlines, choke and kill lines, and injection lines. As depicted in FIG. 1, the fluid lines 24 also include chokes 26 and valves 28 for regulating fluid flow through the fluid lines 24. Like the chokes 18 and the valves 20, the chokes 26 and the valves 28 can be provided in various forms.

As may be appreciated, chokes and other valves include a flow control mechanism for selectively allowing flow through the valves. For instance, a gate valve includes a sliding gate having an aperture that may be moved into and out of alignment with the bore of a conduit to allow or inhibit flow. A choke can similarly include a movable element that is translated with respect to a stationary component to regulate flow through the choke. Adjustable chokes and other valves are often controlled with actuators coupled to their movable elements. One example of such an arrangement is generally illustrated in FIG. 2.

In this embodiment, a valve 32 includes a valve trim 34 disposed within a hollow valve body 36. The valve 32 can have any suitable configuration. For instance, the valve trim 34 could be a plug-and-cage trim or a sleeve trim, to name but two examples. Further, it will be appreciated that the valve 32 could be used in the system 10 (e.g., as a choke 18, a valve 20, a choke 26, or a valve 28).

An actuator 38 is coupled to a control component of the trim 34 to drive movement of the control component to regulate flow through the valve 32. As described in greater detail below, in at least some embodiments the actuator 38 enables different manners of movement of the control component (e.g., linear and rotational movement) within the valve body during operation of the valve. A motor 40 is coupled to the actuator 38 to drive movement of the control component via the actuator. The motor 40 (e.g., an electric motor or a hydraulic motor) provides a mechanical input to the actuator 38, which then converts this input to a mechanical output to move the control component of the valve trim 34 and regulate flow through the valve 32.

Operation of the motor 40 can be controlled in any suitable fashion, such as by a controller 42. In at least one embodiment, the controller 42 includes a memory device and a processor for executing instructions stored within the memory device to generate control signals to the motor that regulate its speed or other operational parameters. The controller 42 can also include or be connected to various input or output devices, such as buttons, a keypad, a keyboard, a display, or the like, to facilitate user interaction and command of the controlled system.

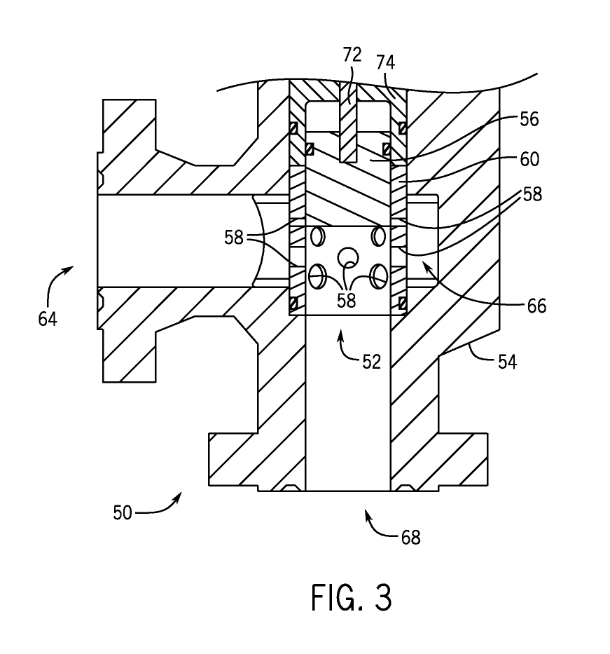

As noted above, the valve 32 can have various configurations, an example of which is depicted in FIG. 3. In this embodiment, the valve (here denoted as valve 50) includes a plug-and-cage trim 52 disposed within a hollow valve body 54. The trim 52 includes a plug 56 disposed within a fluid conduit or cage 60. The plug 56 and the cage 60 can be moved with respect to one another so that the plug 56 selectively covers ports 58 in the cage 60 to control flow of fluid through the valve 50. The ports 58 are shown in FIG. 3 as an example, but it will be appreciated that the cage 60 could have more ports in some embodiments and fewer ports (even a single port) in other embodiments, and that the ports could be arranged in any desired fashion.

As shown here, the valve 50 includes openings 64 and 68, one of which serves as an inlet and the other of which serves as an outlet. For instance, in one embodiment fluid flows into the valve 50 through the opening 64 (i.e., the inlet) passes to a cavity 66, through available ports 58 into the cage 60 (i.e., through those ports 58 that are not closed with the plug 56), and out through the opening 68 (i.e., the outlet). In other instances, the functions of openings 64 and 68 could be reversed, so that fluid flows into the valve 50 through the opening 68 and out of the valve through the opening 64.

Flow through a valve is regulated by moving a control component or element of the valve trim. In the case of valve 50, this control component is the plug 56, which can be moved within the cage 60 to block or open various ports 58 to selectively inhibit flow through these ports and, consequently, between the inlet and the outlet of the valve. The plug 56 can be moved with respect to the cage 60 by a stem 72 coupled to the actuator 38. For instance, with the stem 72, the actuator 38 can drive the plug 56 linearly within the valve 50 (that is, along the axis of the cage 60). In this manner, the plug 56 can be moved to reduce or increase the flow area through the wall of the cage 60 (i.e., the area of the ports 58 uncovered by the plug 56). In the example of FIG. 3, the plug 56 may be extended downward to decrease the flow area by covering a greater portion of the ports 58, and may be retracted upward to increase the flow area by covering a lesser portion of the ports 58. As noted above and discussed in greater detail below, the plug 56 could also be rotated (e.g., about the axis of the cage 60) to more evenly distribute wear caused by flow through the ports 58. In the presently depicted embodiment, the plug 56 is the movable control component and the cage 60 is held stationary within the valve body 54 with a retainer 74. In other embodiments, however, the plug could be held stationary while the cage is the control component that is moved by an actuator to regulate flow.

Valve trims are typically wearing elements of a valve. More specifically, flowing fluids can erode valve trim components. While trim components can be formed from hard, wear-resistant steels or other materials (e.g., tungsten carbide), even these materials may erode over time. This erosive wear can have various causes, such as abrasion and cavitation. Moreover, the rate at which such erosive wear occurs can depend on factors such as flow conditions and the amount and type of abrasive particles present in the regulated fluid. In at least some embodiments of the present technique, however, a valve trim component is rotated to distribute such erosive wear over a larger area and extend the operating life of the trim.

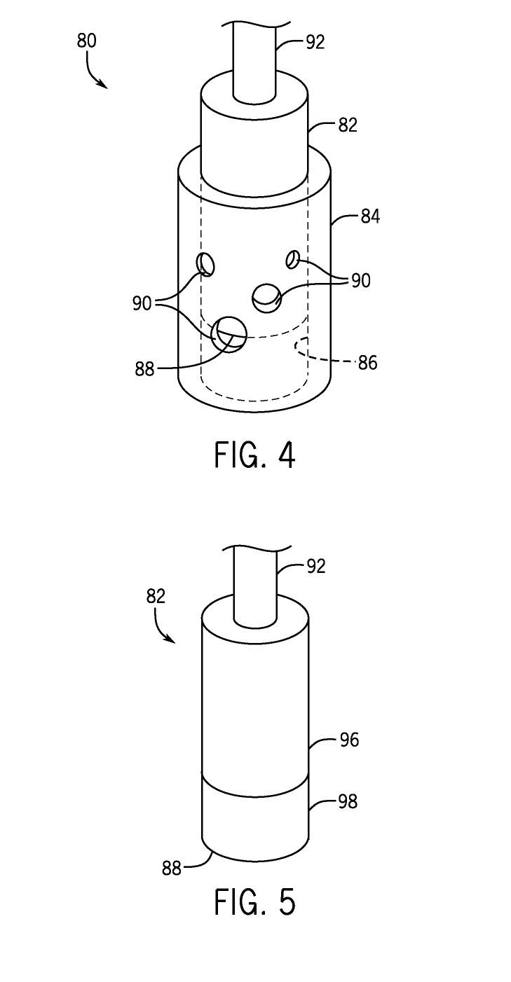

Additional details regarding such wear and rotation may be better understood with reference to FIGS. 4-7. In FIG. 4, a plug-and-cage trim 80 is depicted as having a plug 82 and a cage 84. The plug 82 is positioned within the bore 86 of the cage 84 and can be moved with respect to the cage 84 to selectively cover ports 90 and regulate flow through the trim 80. Four ports 90 are depicted in FIG. 4 for the sake of clarity and explanation, but the number and arrangement of ports 90 can vary in other embodiments (as noted above with respect to the cage 60).

The plug 82 can move (e.g., driven by actuator 38 via stem 92) between a fully open position, in which all ports 90 are left uncovered for maximum flow area, and a fully closed position, in which all ports 90 are covered to block flow through the trim. As the plug 82 is moved from the fully open position to the fully closed position, a controlling edge 88 of the plug 82 is the first portion of the plug 82 to cover the ports 90 and interrupt flow through these ports. Likewise, the controlling edge 88 is the last portion of the plug 82 to inhibit flow through the ports 90 as the plug 82 is moved from the fully closed position to the fully open position. As this controlling edge 88 passes the ports 90, the portions of the controlling edge 88 exposed to flow through the ports are subject to erosion.

The plug 82 can be formed with wear-resistant materials to reduce erosion. In one embodiment depicted in FIG. 5, the plug 82 includes an upper portion 96 and a lower portion 98. The upper and lower portions 96 and 98 can be formed of, or covered with, wear-resistant materials. Because it includes the controlling edge 88, the lower portion 98 in at least some embodiments is formed of or covered with a material with greater wear resistance than that of the upper portion 96. For instance, the exterior of the lower portion 98 can be tungsten carbide and the upper portion 96 can be steel.

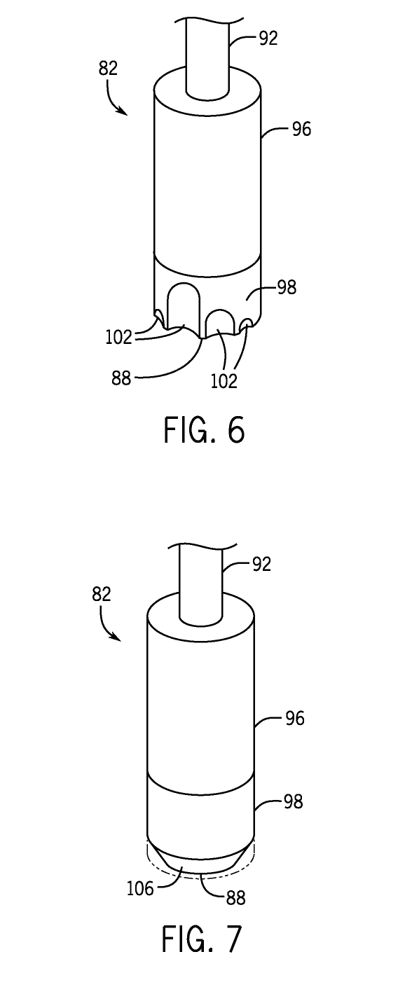

Even with such construction, however, flow through the ports 90 can erode the plug 82 along the controlling edge 88. By way of example, prolonged or repeated exposure of the controlling edge 88 to fluid flowing through the ports 90 can lead to wear channels 102 being formed in the lower portion 98 from erosion, as generally depicted in FIG. 6. These channels 102 are formed along the controlling edge 88 at circumferential portions of the lower portion 98 corresponding to the locations of the ports 90 that are selectively covered by these circumferential portions. As the plug 82 is moved linearly back and forth to regulate flow through the ports 90, the fluid passing through the ports erodes those portions of the controlling edge 88 exposed to the flow at the ports.

As noted above, however, in at least some embodiments a control component of a valve trim is also rotated within a valve. In one example, the plug 82 can not only be moved linearly to regulate flow through a valve, but can also be rotated to more evenly distribute erosive wear over a larger area of the plug along the controlling edge 88. Specifically, by rotating the plug 82, the portions of the controlling edge 88 aligned with and exposed to flow through the ports 90 can be varied to spread the wear over a greater portion (or even the entirety) of the controlling edge 88. For instance, as depicted in FIG. 7, rotation of the plug 82 can distribute erosive wear over a surface 106 about the circumference of the plug 82 along the controlling edge 88. In this figure, the original contour of the end of the plug 82 with the controlling edge 88 (i.e., before erosive wear) is depicted in phantom for the sake of comparison with the surface 106.

The rotation of a valve trim component (e.g., plug 82) to distribute erosive wear can be accomplished in any suitable manner, such as manually or via an actuator. In some embodiments, the actuator 38 of FIG. 2 can be provided as two separate actuators—a linear actuator and a rotational actuator. In other embodiments, the actuator 38 can be provided as a single actuator that enables both axial motion and rotational motion of a control component (e.g., plug 82) with respect to a flow-restricting component (e.g., cage 84). Further, the actuator 38 (whether provided as a single actuator or multiple actuators) could rotate and translate the control component simultaneously or at different times.

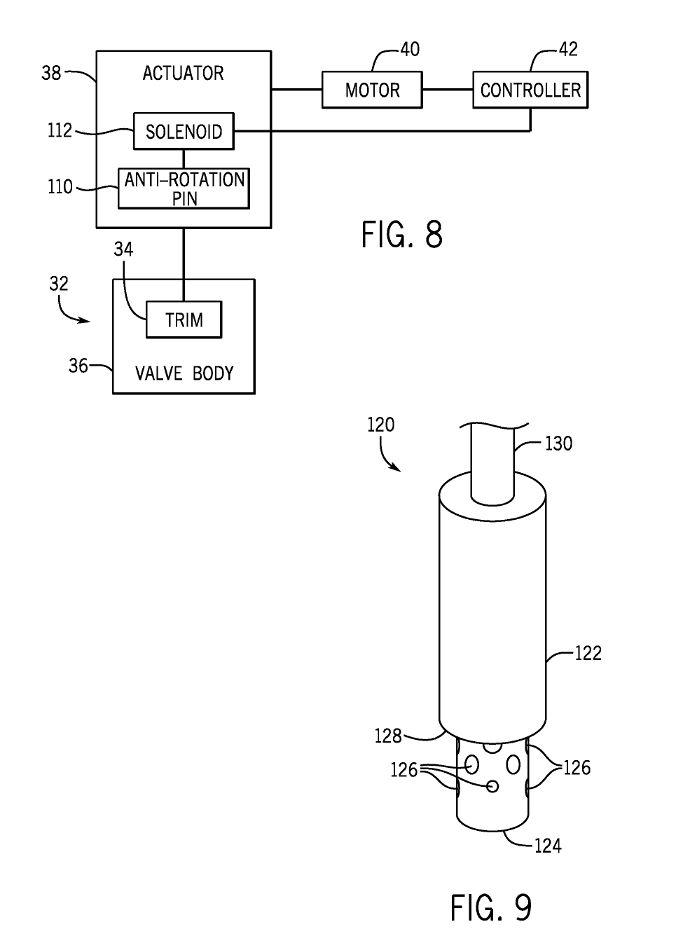

One example of a single actuator for rotating and translating a control component is generally depicted in FIG. 8, in which the actuator 38 includes an anti-rotation pin 110 controlled by a solenoid 112. The anti-rotation pin 110 selectively prevents rotation of the control component within a valve. For instance, the anti-rotation pin 110 can engage a slot in a stem connecting the actuator 38 with the control component of the trim to prevent rotation of the stem and the control component while allowing axial movement of the stem and the control component. The anti-rotation pin 110 can be withdrawn from that slot to then allow both axial and rotational movement of the stem (and the control component) by the actuator 38. In the depicted embodiment, the position of the anti-rotation pin 110 is regulated by the solenoid 112, which itself is controlled via the controller 42. In other embodiments, a clutch could also or instead be used to selectively enable rotation of the control component.

The frequency with which a valve trim component is rotated can depend on flow characteristics or other parameters. For instance, in some embodiments the plug 82 or another valve trim component could be rotated only occasionally, such as daily or weekly. In other embodiments, the valve trim component could be rotated continually, such as according to a periodic schedule or each time the valve trim is in a certain position (e.g., completely open or completely closed). The valve trim component could also be rotated continuously during operation of a valve. The rate and amount by which valve trim components are rotated can also differ.

While rotation of a valve trim component to distribute erosive wear is described above with respect to plug-and-cage trims 52 and 80, it is again noted that such techniques could also be used with other trims. For example, rotation of a trim component can be used to distribute erosive wear in trim 120 depicted in FIG. 9. The trim 120 is a sleeve trim having a sleeve 122 and a conduit 124. The sleeve 122 can be moved along the conduit 124 (via stem 130) to selectively cover ports 126 in the conduit 124 and control the rate at which fluid flows through a valve in which the trim 120 is disposed. As here depicted, the sleeve 122 is an external sleeve about the conduit 124, but the sleeve could be provided within the conduit instead. Like the plug-and-cage embodiments described above, flow through ports 126 can erode portions of the controlling edge 128 positioned over the ports. Consequently, the sleeve 122 can be rotated in the manner described above to distribute erosive wear over a greater portion of the controlling edge 128 and extend the operating life of the sleeve 122.

The sleeve 122 can function as the control component, with the sleeve 122 translated along and rotated about a stationary conduit 124. In other instances, the sleeve 122 could be stationary and the conduit 124 could be translated and rotated with respect to the sleeve, or one of these components could be moved axially and the other could be rotated. (The same is true of the plug-and-cage embodiments—while the plug can be translated and rotated with respect to a stationary cage, the cage could also or instead move with respect to the plug.) The movement of one or both components could be performed by a single actuator, by multiple actuators, or manually, as described above. Finally, while the various trims are depicted in the figures as single-stage trims, it is noted that the same techniques can also be applied with multi-stage trims (e.g., trims constructed to regulate pressure changes of fluid passing through the trims and reduce cavitation) to more evenly distribute erosive wear.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. A valve comprising:
a hollow body with an inlet and an outlet;
a trim disposed inside the hollow body, the trim having a control component that can be moved to regulate flow from the inlet to the outlet; and
an actuator coupled to the trim, wherein the actuator enables both linear movement of the control component and rotational movement of the control component within the hollow body during operation of the valve.

2. The valve of claim 1, wherein the actuator enables linear movement of the control component to regulate flow from the inlet to the outlet and rotational movement of the control component to distribute erosive wear of the control component from the flow over a larger area of the control component.

3. The valve of claim 1, wherein the trim is a plug-and-cage trim having the control component in the form of a plug that is moveable within a cage by the actuator to selectively inhibit flow through the valve.

4. The valve of claim 1, wherein the trim includes a conduit and a sleeve arranged to selectively cover fluid ports in the conduit.

5. The valve of claim 4, wherein the sleeve is an external sleeve disposed about the conduit.

6. The valve of claim 4, wherein the sleeve is the control component.

7. The valve of claim 1, wherein the trim is a single-stage trim.

8. The valve of claim 1, wherein the actuator enables both linear movement and rotational movement of the trim component simultaneously.

9. The valve of claim 1, wherein the valve is a choke.

10. A system comprising:
a valve body;
a valve trim disposed in the valve body, the valve trim including a first component and a second component, wherein the first component and the second component can be moved with respect to one another to regulate flow through a port in the first component;
an actuator coupled to the valve trim, wherein the actuator enables relative rotational motion of the first component with respect to the second component such that different circumferential portions of the second component are exposed to flow through the port at different times.

11. The system of claim 10, wherein the actuator enables both relative rotational motion and relative axial motion of the first component with respect to the second component.

12. The system of claim 11, comprising a motor coupled to drive the actuator.

13. The system of claim 12, wherein the actuator includes a solenoid-controlled anti-rotation pin for selectively preventing relative rotational motion of the first component with respect to the second component.

14. The system of claim 10, wherein the second component is a plug disposed within the first component.

15. The system of claim 10, wherein the second component is a sleeve disposed about the first component.

16. A method comprising:
moving a control element of a valve trim in a first manner to regulate flow through a valve; and
moving the control element of the valve trim in a second manner to distribute wear over a controlling edge of the control element due to the flow through the valve.

17. The method of claim 16, wherein moving the control element of the valve trim in the first manner includes translating the control element along an axis and moving the control element of the valve trim in the second manner includes rotating the control element about the axis.

18. The method of claim 17, comprising selectively actuating an anti-rotation pin to enable movement of the control element of the valve trim in the second manner by an actuator.

19. The method of claim 16, wherein moving the control element of the valve trim in the second manner includes moving the control element of the valve trim in the second manner during movement of the control element of the valve trim in the first manner.

20. The method of claim 16, wherein moving the control element of the valve trim in the second manner includes manually rotating the control element.
